(19) United States
(12) Patent Application Publication
(10) Pub. No.: US 2006/0265479 A1
(43) Pub. Date: Nov. 23, 2006

(54) Communication network and a method for extending transmission range of the communication network

(76) Inventor: Bjorn Runaker, Spanga (SE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/415,568

(22) Filed: May 2, 2006

(30) Foreign Application Priority Data
May 2, 2005 (EP) EP05009615.5

(51) Int. Cl. G06F 15/177

(52) U.S. Cl. 709/220

(57) ABSTRACT

The invention relates to a communication network comprising a wireless local area network with a number of access points and clients. The communication network is operable to extent the range of the wireless local area network. Each of the clients is adapted to switch between a first mode in which the client is connected to and exchanges packets with an access point and a second mode in which the client is not connected to any of the access points. A client located outside the coverage of any of the access points and requesting to be connected to the wireless local area network is operable as an ad-hoc client by making use of the second mode. A client located within the coverage of one of the access points and the ad-hoc client, is operable as a repeater client sharing its bandwidth with the ad-hoc client by making use of both the first and the second mode.

### REFERENCE TO RELATED APPLICATIONS

This application claims the benefit of the priority date of European application EP 05 009 615.5, filed on May 2, 2005, the contents of which are herein incorporated by reference in their entirety.

### FIELD OF THE INVENTION

The invention relates to a communication network, such as a WLAN (wireless local area network) for extending a transmission range of the communication network, and to a method for extending a transmission range of a communication network, such as a WLAN. The invention also relates to at least one computer program product for extending the range of a communication network.

### BACKGROUND OF THE INVENTION

Wireless LAN (local area network) terminals are often mobile, and it is not always possible to plan the network to get coverage for all terminals.

Consequently, there exists a need for extending a transmission range of a communication network, without adding or changing higher level protocols which could hinder acceptance.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The invention is directed to a system comprising a wireless local area network (WLAN) with a number n of access points, wherein n is an integer, and n≧2. The system comprises a number m of clients, wherein m is an integer, and m≧2. The system is operable to extend the range of the wireless local area network. Each of the clients are configured to switch between a first mode in which the client is connected to and exchanges packets with an access point, and a second mode in which the client is not connected to any of the access points. A client located outside the coverage of any access point, and requesting to be connected to the wireless local area network, is operable as an ad-hoc client by making use of only the second mode. A client located within the coverage of both one of the access points and the ad-hoc client, is operable as a repeater client sharing its bandwidth with the ad-hoc client by making use of both the first and second mode.

One advantage with the system according to the invention is that the functionality to WLAN terminals is increased without major redesigns. Another advantage is that no changes need to be done to the access points. A yet further advantage is that the solution is achieved without adding or changing higher level protocols.

A further advantage may be achieved if each client comprises a storage device adapted to store queued packets.

Furthermore, it is an advantage in one embodiment if the repeater client, when operating in the first mode, is adapted to transmit the queued packets received from the ad-hoc client to one of the access points, and to receive the packets from one of the access points destined for the ad-hoc client.

A further advantage in one embodiment may be achieved if the repeater client, when operating in the second mode, is adapted to be connected to the ad-hoc client and to exchange all the queued packets.

Furthermore, it is an advantage in one embodiment if the repeater client, when switching from the first mode to the second mode, signals a power save mode to one of the access points, wherein one of the access points is adapted to queue packets destined for the repeater client while it is operating in the second mode.

A further advantage in one embodiment may be achieved if the communication network also comprises a local server, wherein all network applications, in one example, are terminated to the local server.

Furthermore, it is an advantage in one embodiment if a network stack of the communication network is modified.

A further advantage in one embodiment may be achieved if the ad-hoc client is adapted to handle a transition from the first mode to the second mode in a transparent way.

In another embodiment, the invention comprises a method for extending the transmission range of a communication network, comprising a wireless local area network with a number n of access points, wherein n is an integer, and n≧2. The communication network comprises a number m of clients, wherein m is an integer, and m≧2. Each of the clients is adapted to switch between a first mode in which the client is connected to and exchanges packets with an access point, and a second mode in which the client is not connected to any access point. The method comprises requesting to be connected to the wireless local area network for a client outside the coverage of any of the access points, and handling the client to be operable as an ad-hoc client by making use of only the second mode. The method further comprises handling a client, which is located within the coverage of one of the access points and the ad-hoc client, to be operable as a repeater client sharing its bandwidth with the ad-hoc client by making use of both the first and said second mode.

One advantage with the method according to the invention is that the functionality to WLAN terminals is increased without major redesigns. Another advantage is that no changes need to be done to the access points. A yet further advantage is that the extension of the transmission range is achieved without adding or changing higher level protocols.

A further advantage in one embodiment may be achieved if each of the clients comprises a storage device operable to store queued packets, and the method further comprises transmitting the first queued packets received from the ad-hoc client to one of the access points via the repeater client, when the repeater client operates in said first mode, and receiving the queued packets from one of the access points destined for the ad-hoc client by the repeater client.

A further advantage in one embodiment may be achieved if the method further comprises connecting the repeater client, when operating in the second mode, to the ad-hoc client and exchanging all the queued packets.

Furthermore, it is an advantage in one embodiment if the method further comprises signalling a power save mode for the repeater client to one of the access points, when the repeater client is switched from the first mode to the second mode, and queuing packets destined for the repeater client in one of the access points, while the repeater client is operating in the second mode.

Furthermore, it is an advantage in one embodiment if the system comprises a local server, and the method further comprises terminating all network applications to the local server.

A further advantage in one embodiment may be achieved if the method further comprises modifying a network stack of the system with time-out parameters modified.

Furthermore, it is an advantage in one embodiment if the method further comprises handling, for the ad-hoc client, a transition from the first mode to the second mode in a transparent way.

According to another embodiment of the invention at least one computer program product is provided for extending the range of a wireless local area network (WLAN). The at least one computer program product may be directly loadable into an internal memory of at least one computer. The product comprises software code portions for performing the method when the at least one product is run on the at least one computer.

One advantage with the computer program product according to the invention is that the functionality to WLAN terminals is increased without major redesigns. Another advantage is that no changes need to be done to the access points. A yet further advantage is that the solution is achieved without adding or changing higher level protocols.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Embodiments of the invention will now be described with reference to the accompanying drawings, in which:

FIG. 1 is a block diagram of a communication network for extending a transmission range of a wireless local area network according to one embodiment of the invention;

FIG. 2 is a flow chart of a method for extending a transmission range of a wireless local area network according to another embodiment of the invention; and

FIG. 3 is a schematic diagram of some computer program products according to yet another embodiment of the invention.

### DETAILED DESCRIPTION OF THE INVENTION

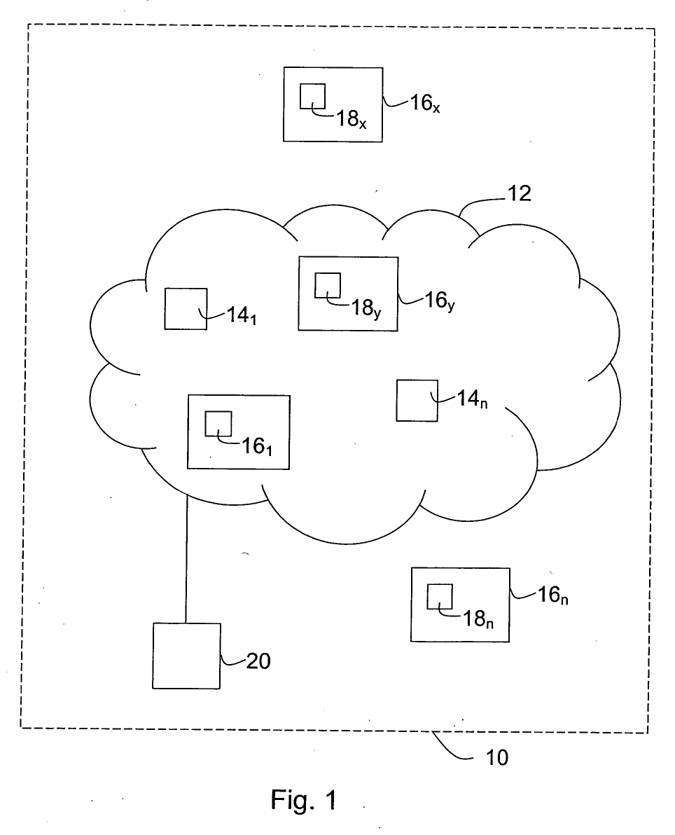

FIG. 1 shows a block diagram of a communication network 10 according to one embodiment of the invention. The communication network 10 comprises a wireless local area network (WLAN) 12 with a number n of access points 14₁, . . . , 14ₙ, wherein n is an integer, and n≧2. The communication network 10 comprises a number m of clients, 16₁, . . . , 16ₘ, wherein m is an integer, and m≧2. The communication network 10 is adapted to extend the transmission range of the wireless local area network 12. Each of the clients 16₁, . . . , 16ₘ, may be able to switch between a first mode in which one of the clients 16₁, . . . , 16ₘ is connected to and exchanges packets with one of the access points 14₁, . . . , 14ₙ, and a second mode in which one of the clients 16₁, . . . , 16ₘ is not connected to any of the access points 14₁, . . . , 14ₙ. In accordance with the invention, an exchange of packets is intended to include either transmission or receipt of data in general, and may include, in particular data in packet format. A client 16ₓ outside the coverage of any access point 14₁, . . . , 14ₙ (in FIG. 1, the access point 14₁) and requesting to be connected to the wireless local area network 12 is operable as an ad-hoc client 16ₓ by making use of only the second mode. A client 16_{y} located within the coverage of any of the access points 14₁, . . . , 14ₙ (in FIG. 1, the access point 14₁) and the ad-hoc client 16ₓ, is operable as a repeater client 16_{y} sharing its bandwidth with the ad-hoc client 16ₓ by making use of both the first and the second mode. In this way the range of the wireless local area network 12 is extended. As illustrated in FIG. 1, each of the clients 16₁, . . . , 16m comprises a storage device 18₁, . . . , 18ₘ adapted to store queued packets. The communication network 10 comprises a local server 20, connected to the wireless local area network 12, wherein all network applications are terminated to the local server 20.

The repeater client 16_{y}, when operating in the first mode, is operable to transmit the queued packets received from the ad-hoc client 16ₓ to the access point 14₁, and to receive the packets from the access point 14₁ destined for the ad-hoc client 16ₓ.

The repeater client 16_{y}, when operating in the second mode, is operable to connect to the ad-hoc client 16ₓ and to exchange all the queued packets.

The repeater client 16_{y}, when switching from the first mode to the second mode, is adapted to signal a power save mode to the access point 14, and the access point is adapted to queue packets destined for the repeater client 16y, for when the repeater client 16_{y} is operated in the second mode.

A network stack (not shown in FIG. 1) of the communication network 10 is modified with time-out parameters.

The ad-hoc client 16ₓ is adapted to handle a transition from the first mode to the second mode in a transparent way.

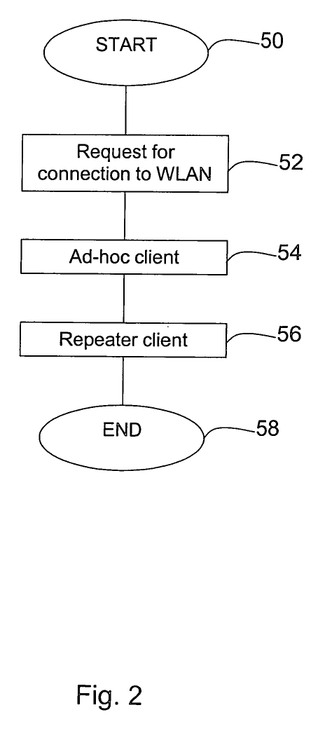

FIG. 2 illustrates a flowchart of a method for extending the range of a wireless local area network (WLAN) 12 (see FIG. 1) according to the invention. While, for purposes of simplicity of explanation, the methodology and variations thereof described below are depicted and described as executing serially, it is to be understood and appreciated that the present invention is not limited by the illustrated order, as some aspects could, in accordance with the present invention, occur in different orders and/or concurrently with other aspects from that depicted and described herein. Moreover, not all illustrated features may be required to implement a methodology in accordance with an aspect the invention.

The method is performed with the aid of a communication network 10 comprising the wireless local area network 12 with a number n of access points 14₁, . . . , 14ₙ, wherein n is an integer, and n≧2. The communication network 10 comprises a number m of clients 16₁, . . . , 16ₘ, wherein m is an integer, and m≧2. Each of the clients 16₁, . . . , 16ₘ is adapted to switch between a first mode in which one of the clients 14₁, . . . , 14ₙ, is connected to and exchanges packets with one of the access points 14₁, . . . , 14ₙ and a second mode in which one of the clients 16₁, . . . , 16ₘ is not connected to any of the access points 14₁, . . . , 14ₙ. The method begins at 50 and continues at 52. A client 16ₓ (see, e.g., FIG. 1) outside the coverage of any of the access points 14₁, . . . , 14ₙ, requests to be connected to the wireless local area network 12. Thereafter, the method continues at 54, wherein the client 16ₓ is operable as an ad-hoc client 16ₓ by making use of only the second mode. The method continues at 56, wherein a client 16_{y}, within the coverage of one of the access points 14₁, . . . , 14ₙ, and the ad-hoc client 16ₓ, operates as a repeater client 16_{y} by sharing its bandwidth with the ad-hoc client 16ₓ and by making use of both the first and the second operating mode. The method is completed at 58. The method according to the invention makes it possible to extend the transmission range of the wireless local area network.

Each of the clients 16₁, . . . , 16ₘ comprises a storage device 18₁, . . . , 18ₘ (see FIG. 1) adapted to store queued packets. The repeater client 16_{y}, when operating in the first mode, transmits the queued packets from the ad-hoc client 16ₓ to one of the access points 14₁, . . . , 14ₙ, and receives the queued packets from one of the access points 14₁, . . . , 14ₙ destined for the ad-hoc client 16ₓ.

The repeater client 16_{y}, when operating in the second mode, is connected to the ad-hoc client 16ₓ and exchanges all the queued packets.

The repeater client 16_{y}, when switching from the first mode to the second mode, signals a power save mode to one of the access points 14₁, . . . , 14ₙ. The access point 14₁, . . . , 14ₙ, queues packets destined for the repeater client 16_{y} while the repeater client is operating in the second mode.

The communication network 10 comprises a local server 20, wherein in one embodiment all network applications are terminated to the local server 20.

A network stack of the communication network 10 is, in one embodiment, modified with time-out parameters modified.

The transition from the first mode to the second mode of the clients is handled, in one example, in a transparent way.

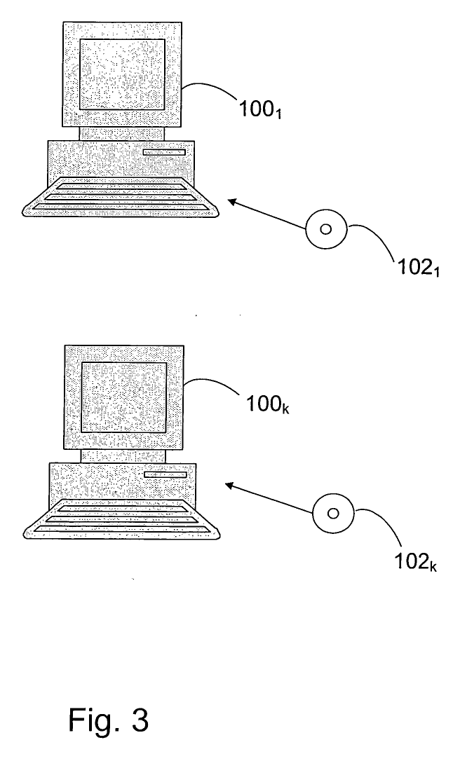

FIG. 3 shows a schematic diagram of some computer program products according to another embodiment of the invention for extending the transmission range of a wireless local area network 12 comprising k different digital computers 100₁, .. , 100ₖ, wherein k is an integer, and k different computer program products 102₁, . . . , 102ₖ, here shown in the form of compact discs. The different computer program products 102₁, . . . , 102ₖ are, in one example, directly loadable into the internal memory of the k different digital computers 100₁, . . . , 100ₖ. Each of the computer program products 102₁, . . . , 102ₖ comprises software code portions for performing some or all of the actions illustrated in FIG. 2 when the product(s) 102₁, . . . , 102ₖ is/are run on the computer(s) 100₁, . . . , 100ₖ. The computer program products 102₁, . . . , 102ₖ may be stored on floppy disks, RAM disks, magnetic tapes, opto magnetical disks or any other suitable products.

Although the invention has been illustrated and described with respect to a certain aspect or various aspects, it is obvious that equivalent alterations and modifications will occur to others skilled in the art upon the reading and understanding of this specification and the annexed drawings. In particular regard to the various functions performed by the above described components (e.g., assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.” Also, exemplary is merely intended to mean an example, rather than the best.

1. A communication network comprising a wireless local area network, the local area network comprising:
a plurality n of access points, wherein n is an integer, and n≧2;
a plurality m of clients, wherein m is an integer, and m≧2,
wherein each of the clients is adapted to switch between a first mode and a second mode, wherein in the first mode a respective client is connected to and exchanges packets with one of the access points, and in the second mode the respective client is not connected to any of the access points, and
wherein the clients are further configured such that a client which is located outside the coverage of any of the access points and requests to be connected to the wireless local area network is configured to operate as an ad-hoc client by making use of only the second mode, and another client, which is located within the coverage of any of the access points and the ad-hoc client, is configured to operate as a repeater client by sharing its bandwidth with the ad-hoc client and by making use of both the first and the second mode.

2. The communication network of claim 1, wherein each of the clients further comprise a storage device adapted to store queued packets therein.

3. The communication network of claim 2, wherein the repeater client, when operating in the first mode, is adapted to transmit the queued packets received from the ad-hoc client to one of the access points, and to receive packets from one of the access points destined for the ad-hoc client.

4. The communication network of claim 2, wherein the repeater client, when operating in the second mode, is operable to connect to the ad-hoc client and to exchange the queued packets.

5. The communication network of claim 2, wherein the repeater client, when switching from the first mode to the second mode, is adapted to signal a power save mode to one of the access points, whereby the one of the access points is adapted to queue packets destined for the repeater client while the repeater client is operating in the second mode.

6. The communication network of claim 1, wherein the communication network further comprises a local server, wherein all network applications are terminated to the local server.

7. The communication network of claim 1, wherein a network stack of the communication network is modified with time-out parameters modified.

8. The communication network of claim 1, wherein the ad-hoc client is configured to transition from the first mode to the second mode in a transparent manner.

9. A method for extending a transmission range of a communication network, the communication network comprising a wireless local area network comprising a plurality n of access points, wherein n is an integer, and n≧2, and a plurality m of clients, wherein m is an integer, and m≧2, and wherein each of the clients is adapted to switch between a first mode in which each of the clients is connected to and exchanges packets with one of the access points, and a second mode in which each of the clients is not connected to any of the access points, the method comprising:
requesting to be connected to the wireless local area network for a client outside the coverage of any access point;
configuring the requesting client as an ad-hoc client by making use of only the second mode thereat; and
configuring another client, which is located within the coverage of one of the access points and the ad-hoc client, wherein the another client is configured as a repeater client to share its bandwidth with the ad-hoc client by making use of both the first and the second mode.

10. The method of claim 9, wherein each of the clients comprises a storage device adapted to store queued packets, the method further comprising:
transmitting the queued packets received from the ad-hoc client to one of the access points via the repeater client, when the repeater client operates in the first mode; or
receiving the queued packets from one of the access points destined for the ad-hoc client by the repeater client.

11. The method of claim 10, wherein the method further comprises connecting the repeater client, when operating in the second mode, to the ad-hoc client to exchange the queued packets.

12. The method of claim 9, wherein the method further comprises:
signalling a power safe mode for the repeater client to one of the access points when the repeater client is switched from the first mode to the second mode; and
queuing packets destined for the repeater client in one of the access points, while the repeater client is operating in the second mode.

13. The method of claim 9, wherein the communication network comprises a local server, wherein the method further comprises terminating all network applications to the local server.

14. The method of claim 9, wherein the method further comprises modifying a network stack of the communication network with time-out parameters modified.

15. The method of claim 9, wherein the method further comprises handling, for the ad-hoc client, a transition from the first mode to the second mode in a transparent manner.

16. A wireless local area network, comprising:
a plurality of access points each having a communication coverage area associated therewith;
a plurality of clients each configured to transmit and receive data;
wherein each of the clients are further configured to selectively operate in one of a first mode and a second mode, wherein in the first mode a respective client is configured to transmit or receive data with an access point, and in the second mode the respective client is configured to transmit or receive data with another client;
wherein a requesting client is further configured to operate as an ad-hoc client and operate only in the second mode when requesting connection to the wireless local area network when located outside the communication coverage area of any access point; and
wherein another client located within the communication coverage area of one of the access points is further configured to operate as a repeater client by sharing its bandwidth with the ad-hoc client, thereby facilitating transmission or receipt of data between the ad-hoc client and the respective access point, thereby extending a range of the wireless local area network.

17. The wireless local area network of claim 16, wherein each of the clients further comprise a storage location associated therewith configured to store data therein.

18. The wireless local area network of claim 17, wherein the repeater client is configured, in the first mode, to transmit data received from the ad-hoc client to the respective access point, or to receive data from the respective access point that is destined for the ad-hoc client.

19. The wireless local area network of claim 17, wherein the repeater client is configured, in the second mode, to transmit data to the ad-hoc client or to receive data therefrom.

20. The wireless local area network of claim 17, wherein the repeater client, when switching from the first mode to the second mode, is adapted to signal a power save mode to one of the access points, whereby the one of the access points is adapted to queue packets destined for the repeater client while the repeater client is operating in the second mode.
